(19) United States
(12) Patent Application Publication
(10) Pub. No.: US 2016/0018861 A1
(43) Pub. Date: Jan. 21, 2016

(54) Hard-Disk Assembly Apparatus

(71) Applicant: Chun-Hsien Wu, New Taipei City (TW)

(72) Inventor: Chun-Hsien Wu, New Taipei City (TW)

(21) Appl. No.: 14/335,958

(22) Filed: Jul. 21, 2014

(51) Int. Cl. G06F 1/18

(52) U.S. Cl. CPC G06F 1/187

(57) ABSTRACT

A hard-disk assembly apparatus includes a storage structure and multiply hard-disk racks. The storage structure in a box format with a positioning device at its outer circumference is configured at different heights according to different industrial computer cases for constituting different storage spaces to be inserted with either the hard-disk racks in different quantities or multiply hard-disk racks together with a DVD device. Thereby the storage structure can be assembled into an industrial computer case without modifying the industrial computer case for achieving a DIY objective as well as both convenience and low cost for the industrial computer assembly.

### TECHNICAL FIELD OF THE INVENTION

The present invention is related to a hard-disk assembly apparatus, particularly a hard-disk assembly apparatus as configured according to different industrial computer cases by inserting hard-disk racks and DVD devices in different quantities into a storage structure for achieving both a DIY objective and convenience for an assembly of the industrial computer.

### DESCRIPTION OF THE PRIOR ART

An industrial computer of the prior art has multiply hard-disk racks directly installed at a case at an assembly of the industrial computer. Therefore the industrial computer of the prior art needs to change a case of different size, which is produced from different manufacture line, when either the hard-disk racks require an increase or decrease or multiply hard-disk racks and DVD devices are to be incorporated. Consequently not only the cost of manufacture increases but also the assembly difficulty raises that users cannot incorporate their needs via DIY on their industrial computers of the prior art. Therefore there is a demand to achieve the convenience in the assembly of hard-disk racks and DVD devices into the industrial computers.

### SUMMARY OF THE INVENTION

An objective of the present invention is to provide a hard-disk assembly apparatus as configured according to different industrial computer cases for inserting a hard-disk rack in different quantity and a DVD device into a storage structure in order to achieve a DIY objective as well as both convenience and low cost for the industrial computer assembly.

The hard-disk assembly apparatus includes the storage structure and multiply hard-disk racks that the storage structure in a box format can be configured at different heights according to different industrial computer cases for constituting different storage spaces to be inserted with either the hard-disk racks in different quantities or multiply hard-disk racks together with a DVD device. Thereby the storage structure can be assembled into an industrial computer case without modifying the industrial computer case for achieving a DIY objective as well as both convenience and low cost for the industrial computer assembly.

The storage structure of the hard-disk assembly apparatus is provided with a positioning device at an outer circumference so as to reach a correct positioning of the storage structure as being assembled into the industrial computer case.

### BRIEF DESCRIPTION OF THE DRAWINGS

FIG. 1 is a perspective diagram illustrating a typical embodiment of the present invention.

FIG. 2 is an assembly diagram illustrating an preferred embodiment of the present invention.

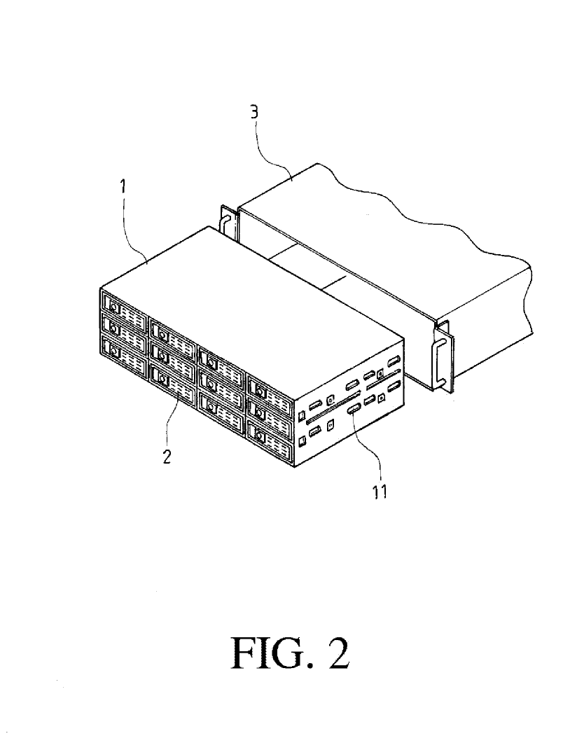

FIG. 3 is a perspective diagram illustrating the preferred embodiment of the present invention assembled into an industrial computer.

FIG. 4 is an assembly diagram illustrating the other embodiment of the present invention.

FIG. 5 is an assembly diagram illustrating a third embodiment of the present invention.

FIG. 6 is an assembly diagram illustrating a fourth embodiment of the present invention.

### DETAILED DESCRIPTION OF THE PREFERRED EMBODIMENTS

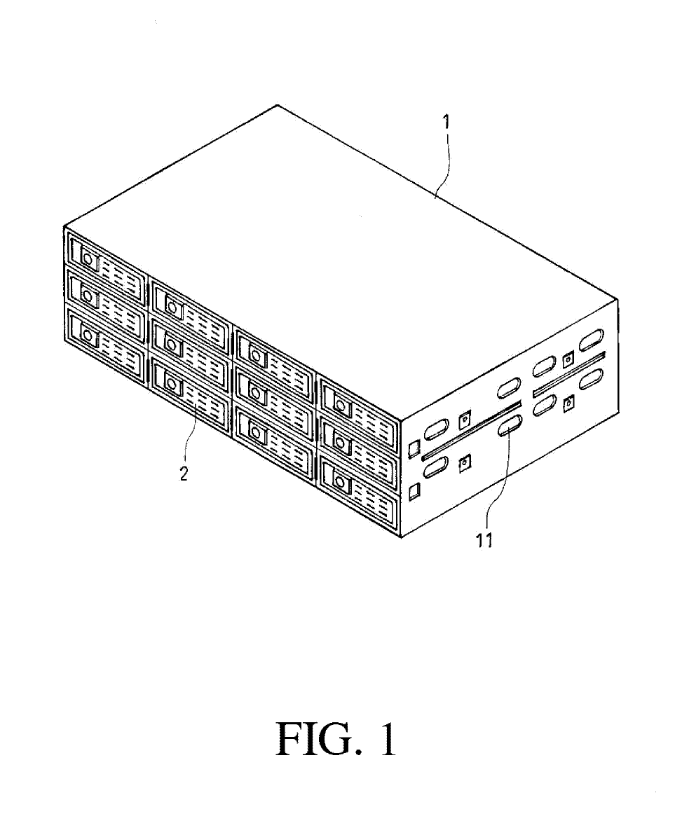

Please refer FIG. 1 and Fig, 2 illustrating a perspective diagram and an assembly diagram of a preferred embodiment of the present invention. As shown, the present invention includes a storage structure 3 and multiply hard-disk racks 2 that the storage structure 1 is in a box format, which can be configured at different heights in accordance with different industrial computer cases for constituting different storage spaces and provided with a positioning device 11 at an outer circumference, in order to insert different quantities of the hard-disk racks 2 into the storage structure 1. In this embodiment the storage structure 1 is in a rectangle shape into which at least twelve hard-disk racks 2 can be inserted.

With the above-mentioned components combination, the storage structure 1 inserted with multiply hard-disk racks 2 is so assembled into an industrial computer case 3 that a correct positioning of the storage structure 1 is reached by the positioning device 11. Therefore an objective of DIY is achieved and a manufacturer needs not modify the industrial computer case 3 for accomplishing both convenience and low cost for the assembly of the industrial computer.

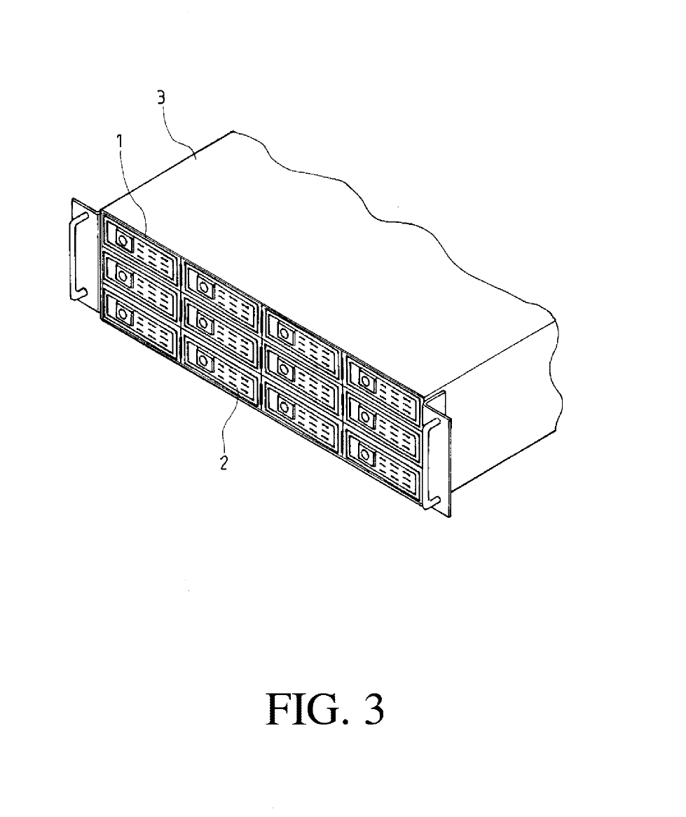

Please refer FIG. 3, a perspective diagram illustrating the preferred embodiment of the present invention assembled into an industrial computer. As shown, the storage structure 1, which is inserted with the multiply hard-disk racks 2, is directly assembled into the industrial computer case 3 without modification required by a change in the quantity of the hard-disk racks 2. Hence the assembly of the industrial computer becomes convenient and also lowers the cost of assembly.

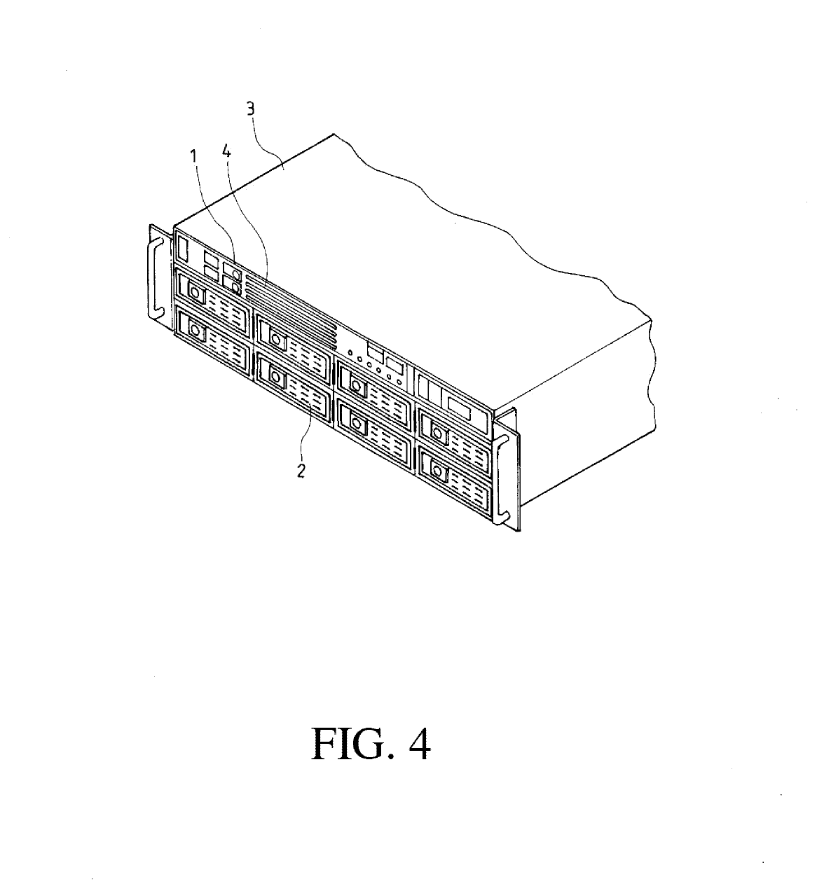

Please refer FIG. 4, an assembly diagram illustrating the other embodiment of the present invention. As shown, the other embodiment of the present invention is to insert the multiply hard-disk racks 2 and a DVD device 4 into the storage structure 1. This embodiment is inserted at least eight hard-disk racks 2 together with the DVD device 4 that the hard-disk racks 2 are arranged at a bottom location while the DVD device 4 is arranged above the hard-disk racks 2. Thereby the storage structure 1 inserted with both the hard-disk racks 2 and the DVD device 4 at the same time can be assembled into the industrial computer case 3.

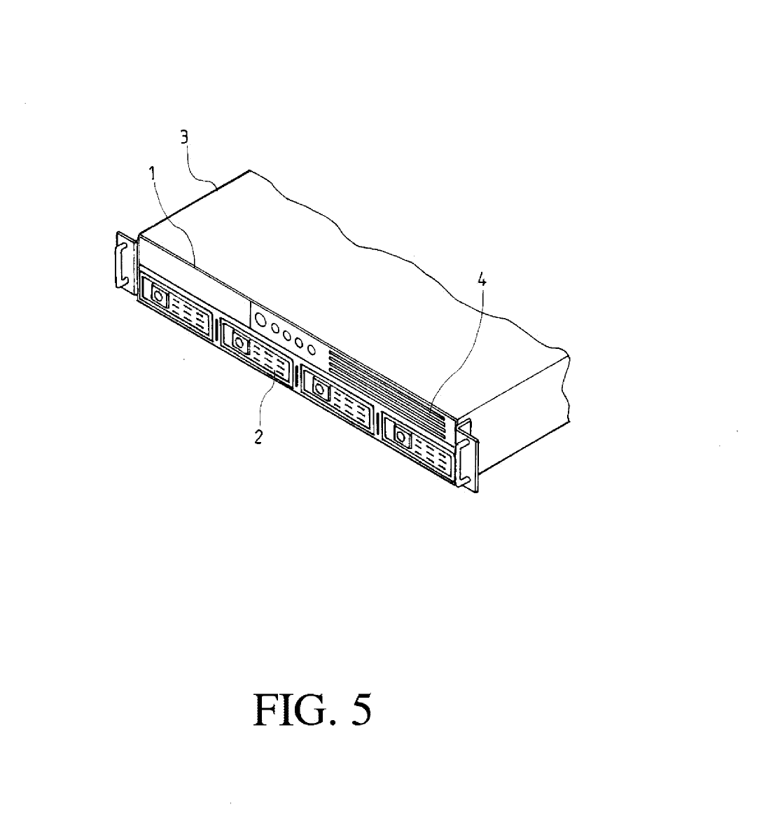

Please refer FIG. 5, an assembly diagram illustrating a third embodiment of the present invention. As shown, the third embodiment of the present invention is to insert the multiply hard-disk racks 2 and the DVD device 4 into the storage structure 1. This embodiment is inserted at least four hard-disk racks 2 together with one DVD device 4 that the hard-disk racks 2 are arranged at a bottom location while the DVD device 4 is arranged above the hard-disk racks 2. Thereby the storage structure 1 inserted with both the hard-disk racks 2 and the DVD device 4 at the same time can be assembled into the industrial computer case 3. This embodiment has the hard-disk racks 2 in one row so that the height of the storage structure 1 is relatively lower after assembly in order to match the industrial computer case 3 in a blade appearance so as to further improve the convenience for the assembly of the industrial computer.

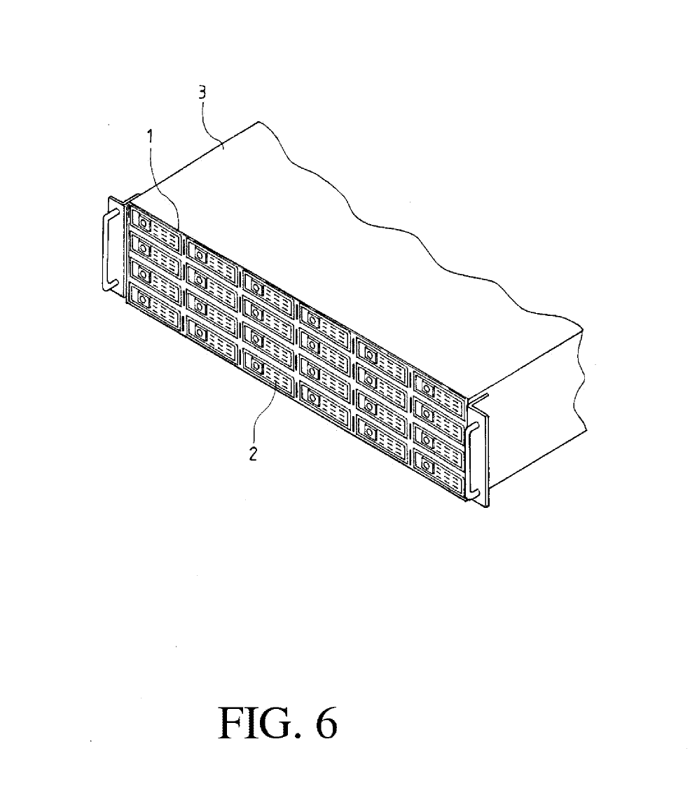

Please refer FIG. 6, an assembly diagram illustrating a fourth embodiment of the present invention. As shown, the third embodiment of the present invention is to insert the multiply hard-disk racks 2 into the storage structure 1. This embodiment is inserted at least twenty four hard-disk racks 2 as arranged in an orderly manner inside the industrial computer case 3. This embodiment has relatively more quantity of the hard-disk racks 2 so as to enhance the utility of the industrial computer.

In addition to the above-mentioned embodiments, the hard-disk racks 2 can be configured in accordance with different needs to a combination of four, eight or other quantity without modifying the industrial computer case 3 in different sizes. Thereby the assembly of the industrial computer achieves both improved convenience at lower cost. It is understood that the foregoing description is that of the preferred embodiments of the present invention and that various changes and modifications may be made thereto without departing from the spirit and scope of the present invention as defined in the appended claims.

I claim:

1. A hard-disk assembly apparatus comprising a storage structure and multiply hard-disk racks wherein said storage structure in a box format to be configured at different heights in accordance with a different industrial computer case for constituting different storage spaces by inserting said hard-disk racks in different quantities into said storage structure so as to be assemble said storage structure with said multiply hard-disk racks into the industrial computer case in position by a positioning device in order to achieve an objective of DIY without modifying the industrial computer case whereby accomplishing both convenience and low cost in an assembly of the industrial computer.

2. The hard-disk assembly apparatus of claim 1 wherein said storage structure is provided with the positioning device at an outer circumference so as to reach a correct positioning for said storage structure at assembly into the industrial computer cases.
